(19) United States
(12) Patent Application Publication
(10) Pub. No.: US 2005/0249658 A1
(43) Pub. Date: Nov. 10, 2005

(54) Solid chlorine dioxide releasing compositions having increased temperature stability and method for delivery of solid chlorine dioxide releasing compositions

(75) Inventor: Bryon J. Tarbet, Highland, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Safe Solid Solutions, Inc.

(21) Appl. No.: 11/111,038

(22) Filed: Apr. 21, 2005

Related U.S. Application Data
(60) Provisional application No. 60/565,136, filed on Apr. 23, 2004.

(51) Int. Cl. C01B 11/02

(52) U.S. Cl. 423/477

(57) ABSTRACT

The creation of chlorine dioxide in a water system can be accomplished by an improved mixture of components that includes a chlorite salt, oxidizing chlorine releasing agent(s) and an acid source and these improved combinations of materials can be pre-measured and delivered into a water system in sealed water soluble containers.

### CROSS-REFERENCE TO RELATED APPLICATIONS

This application claims priority to and the benefit of U.S. Provisional Patent Application Ser. No. 60/565,136, filed on Apr. 23, 2004 and entitled Solid chlorine dioxide releasing compositions having increased temperature stability and method for delivery of solid chlorine dioxide releasing compositions which is incorporated by reference in its entirety.

### BACKGROUND OF THE INVENTION

The present invention relates to solid compositions capable of producing and releasing chlorine dioxide (ClO₂), upon dissolution in an aqueous solution, which compositions have increased temperature stability when compared to those compositions previously known in the art as well as a method of delivery for solid chlorine dioxide compositions.

Chlorine dioxide has long been known as an exceptional biocide, virucide, bactericide, fungicide, algaecide and/or sporocide. Its effectiveness and lack of a halogenation (or chlorination) reaction make its use particularly desirable. However, the commercial application of chlorine dioxide as a gas has been limited given the difficulty of storage and transportation.

Various combinations of solid materials have been developed that are capable, in varying degrees of production of chlorine dioxide when these solids are dissolved into an aqueous solution. Such combinations include a water-soluble chlorite salt, a chlorocyanurate salt (which acts as an oxidizing chlorine releasing agent) and an acid (typically bisulfate). While this type of combination can be effective in creating chlorine dioxide when dissolved in water, this type of combination is unstable even at room temperature. The instability leads to a slow but spontaneous decomposition of the material and production of chlorine dioxide gas even in the absence of water vapor.

Some efforts have been made to create stable chlorine dioxide producing solid materials. This has included dilution of the reactants with inert materials such as desiccants, as well as the segregation (either physically or chemically) of each reactant component in the mixture.

Additionally, since the solid components used to create the chlorine dioxide in the aqueous solution are typically available as powdered solids, it is desirable to find a method for delivery of these materials that reduces the quantity of fine powder. Further, since water vapor (humidity) can initiate the reaction process it is also desirable to lessen the impact of any such water vapor on the solid components. It is preferable to use anhydrous ingredients for the same reasons and all reagents used in the examples provided below were anhydrous grade or otherwise dried reagents. Compaction of the solids into tablets, briquettes or other such forms is known. While this type of technique can reduce the quantity of fine powder, it is generally ineffective in preventing the composition's reaction with water vapor. Further, where large quantities of material are routinely used to treat large quantities of water, the use of briquettes/tablets is not ideal.

### BRIEF SUMMARY OF THE INVENTION

The present invention provides a combination of solid materials capable of producing chlorine dioxide when these solids are dissolved into an aqueous solution where the combination has increased temperature stability when compared to presently known materials. Further, the present invention further provides an improved method for delivery of solid chlorine dioxide producing materials.

This improved temperature stability is achieved by utilizing a combination of a first oxidizing chlorine releasing agent such as a chlorocyanurate salt and a second oxidizing chlorine releasing agent such as a hypochlorite containing material in conjunction with an acid or acid producing compound and a soluble chlorite salt. Further temperature stability can be achieved by use of an acid source such as a solid acid with a pKa of between about 2.8 and 6 or an acid producing compound or material. These two modifications can be used independently to improve the temperature stability of existing chlorine dioxide producing formulations, but the best results are achieved when both a combination of chlorocyanurate salt and a or hypochlorite containing material and a solid acid source such as either a solid acid with a pKa of between about 2.8 and 6 or an acid producing compound or material are used. Additionally, additives such as desiccant can also be added to improve the stability of the composition in the presence of water vapor.

Also an improved method of delivery of solid chlorine dioxide producing materials has been developed where a specific quantity of the solid chlorine dioxide producing material is placed in a sealed water-soluble bag or pouch. This allows for specific, pre-measured quantities of solid chlorine dioxide producing material to be pre-packaged, typically for each use, and further allows for preferably multiple sealed water-soluble bags or pouches to be further sealed into re-sealable, air-tight containers so as to allow a user to store multiple days worth of materials without the concern that humidity or water vapor will cause decomposition of those materials.

### DETAILED DESCRIPTION OF THE PREFERRED EMBODIMENTS

An improved temperature stable, solid material for producing chlorine dioxide when introduced into an aqueous solution includes a mixture of a chlorite salt, a combination of first and second oxidizing chlorine releasing agents and an acid source, with the acid source being either a solid acid preferably having a pKa between about 2.8 and 6 or an acid producing compound or material.

In the present invention any of the soluble metal chlorite salts are acceptable for use in the composition, with sodium chlorite being the most common.

The combination of oxidizing chlorine-releasing agents will include a first oxidizing chlorine releasing agent consisting of at least one of the components from the chlorocyanurate family (i.e., a chlorocyanurate) and a second oxidizing chlorine releasing agent such as a hypochlorite containing material consisting of at least one hypochlorite containing material. The most typical members of the chlorocyanurate family will be either the sodium or potassium dichloroisocyanurate (commonly known as DCC) or the sodium or potassium trichloroisocyanurate (commonly known as TCC). Likewise, the most typical hypochlorite containing materials are the lithium or calcium hypochlorite salts.

Any combination of a chlorocyanurate and hypochlorite containing material will improve the temperature stability of the combination when compared to the same fundamental combination having only a single oxidizing chlorine-releasing agent. However, the preferred ratio (by mass) of the hypochlorite containing material and the chlorocyanurate is between 1:10 and 10:1 with a more preferred ratio of between 4:1 and 1:4 and the most preferred ratio of between 1.5:1 and 2.5:1.

Additionally, while any acid source may be used, further temperature stability can be obtained by the use of either a solid acid having a pKa between 2.8 and 6 or by the use of acid producing materials or compounds. Those solid acids presently preferred would include, without limitation, such acids as citric acid, crystalline phosphoric acid, polycarboxcylic acids, sodium/potassium phosphonate (also known as HEDP), sodium dihydrogen phosphate and the related polyphosphates. The acid source can also be solid acid producing materials or compounds that create hydrogen protons when added to water. These compounds could include such materials as aluminum sulfate, ferrous sulfate, ferric chloride as well as the other first row transition metal salts. Inasmuch as the hydrogen proton of the acid source is not needed until the combination or mixture is placed in an aqueous solution, the acid producing compounds provide additional stability to the dry mixture because they lack the hydrogen ions necessary for chlorine dioxide production. Since aluminum is typically already used as a water treatment compound, aluminum sulfate will be the most common reagent used.

Further, for additional stability in the presence of water vapor, a desiccant such as, but not limited to, sodium sulfate, magnesium sulfate or aluminum sulfate can be added, typically not to exceed 50% of the total combination (by mass). Further, while, for example, the commercially available aluminum sulfate is highly hydrated, the aluminum sulfate can be dried or otherwise dehydrated by known methods prior to its inclusion into the mixture. Once dehydrated, the aluminum sulfate becomes an effective desiccant as well as acid source, thereby reducing the overall quantity of material needed.

In order to improve the delivery and use of a solid chlorine dioxide producing material a method to eliminate fine dust-like particles has been developed. In this method, a pre-determined quantity of the solid chlorine dioxide producing material is placed in a sealed, water-soluble bag, pouch or other container. This pre-determined quantity can be specifically tailored to the amount of material needed for a single treatment of a given body of water (whether large or small). Since a typical treatment will contain enough material to produce approximately 0.2-3 ppm of chlorine dioxide in the water (with 2 ppm being the most typical), the desired quantity of chlorine dioxide producing material can be accurately determined by simply knowing the volume of water to be treated. The present method will allow for each treatment to be accurately determined without requiring any additional measurement or calculation by the end user. The container will most preferably be made of a high molecular-weight starch (or similar) material that cannot serve as a food source for bacteria or other water-borne organisms. The two most common forms for the container are water-soluble paper and polyvinyl alcohol (PVA). These types of containers eliminate any fine dust-like particles and also prevent contact between the user and the solid chlorine dioxide producing material. Additionally, this container will further reduce the effect of water vapor on the solid chlorine dioxide producing material contained within it and these containers readily allow for preferably multiple sealed water-soluble containers to be further sealed into re-sealable, air-tight containers so as to allow a user to store multiple days worth of materials without the concern that humidity or water vapor will cause decomposition of those materials.

Examples of various solid chlorine dioxide producing materials are as follows:

### EXAMPLE 1

7.6 grams sodium chlorite;
6.0 grams citric acid;
1.0 gram sodium dichloroisocyanurate (DCC);
2.0 grams lithium hypochlorite; and
15.0 grams of sodium sulfate

All ingredients were powdered and the combination yielded greater than 85% of theoretical concentration when mixed with water and was stable at a temperature in excess of 140° F.

### EXAMPLE 2

7.6 grams sodium chlorite;
6.0 grams citric acid;
1.0 gram sodium dichloroisocyanurate (DCC);
2.0 grams lithium hypochlorite;
13.0 grams of sodium sulfate; and
3.0 grams of magnesium sulfate

All ingredients were powdered and the combination yielded greater than 85% of theoretical concentration when mixed with water and was stable at a temperature in excess of 140° F.

### EXAMPLE 3

7.6 grams sodium chlorite;
6.0 grams sodium bisulfate;
1.0 grams sodium dichloroisocyanurate (DCC);
2.0 grams lithium hypochlorite; and
15.0 grams of sodium sulfate

All ingredients were powdered and the combination yielded greater than 85% of theoretical concentration when mixed with water and was stable at a temperature in excess of 120° F.

### EXAMPLE 4

10.2 grams sodium chlorite;
8.46 grams citric acid;
1.26 grams sodium dichloroisocyanurate (DCC);
2.0 grams lithium hypochlorite; and
7.08 grams of sodium sulfate

All ingredients were powdered and the combination yielded greater than 85% of theoretical concentration when mixed with water and was stable at a temperature in excess of 140° F.

### EXAMPLE 5

10.2 grams sodium chlorite;
8.46 grams citric acid;
1.26 grams sodium dichloroisocyanurate (DCC);
2.0 grams lithium hypochlorite;
5.67 grams of sodium sulfate; and
1.41 grams of magnesium sulfate

All ingredients were powdered and the combination yielded greater than 85% of theoretical concentration when mixed with water and was stable at a temperature in excess of 140° F.

### EXAMPLE 6

10.2 grams sodium chlorite;
1.26 grams sodium dichloroisocyanurate (DCC);
2.0 grams lithium hypochlorite; and
15.5 grams of aluminum sulfate

All ingredients were powdered and the aluminum sulfate was dehydrated prior to its inclusion in this mixture by heating it to 160° F. for approximately 24 hours. The combination yielded greater than 90% of theoretical concentration when mixed with water and was stable at a temperature in excess of 160° F.

### EXAMPLE 7

10.2 grams sodium chlorite;
3.3 grams sodium dichloroisocyanurate (DCC); and
15.5 grams of aluminum sulfate

All ingredients were powdered and the aluminum sulfate was dehydrated prior to its inclusion in this mixture as above. The combination yielded greater than 90% of theoretical concentration when mixed with water and was stable at a temperature in excess of 140° F.

### EXAMPLE 8

The product from Example 7 was put into a heat sealed PVA bag and the last side was sealed using a standard jaw-type heat sealing device at 100° C. The bag was inspected for 2 weeks for signs of degradation and none were found.

### EXAMPLE 9

The product from Example 7 was put into a heat sealed paper bag and the last side was sealed using a standard jaw-type heat sealing device at 125° C. The bag was inspected for 4 weeks for signs of degradation and none were found.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A mixture for production of chlorine dioxide in water, said mixture comprising:
(a) a chlorite salt,
(b) a combination of oxidizing chlorine releasing agents, and
(c) an acid source.

2. A mixture for production of chlorine dioxide in water as recited in claim 1, said mixture further comprises a desiccant.

3. A mixture for production of chlorine dioxide in water as recited in claim 1, wherein said combination of oxidizing chlorine releasing agents contains both a hypochlorite containing material and a chlorocyanurate.

4. A mixture for production of chlorine dioxide in water as recited in claim 1, wherein said acid source is a solid acid having a pKa between 2.8 and 6.

5. A mixture for production of chlorine dioxide in water as recited in claim 4, wherein said solid acid is chosen from among the group of citric acid, crystalline phosphoric acid, polycarboxcylic acids, sodium/potassium phosphonate and sodium dihydrogen phosphate.

6. A mixture for production of chlorine dioxide in water as recited in claim 1, wherein said acid source is an acid producing compound.

7. A mixture for production of chlorine dioxide in water as recited in claim 6, wherein said acid producing compound is aluminum sulfate.

8. A mixture for production of chlorine dioxide in water as recited in claim 7, wherein said aluminum sulfate is dehydrated prior to its inclusion into said mixture.

9. A mixture for production of chlorine dioxide in water as recited in claim 3, wherein said hypochlorite containing material and said chlorocyanurate are present in said mixture at a ration of between 1:10 and 10:1.

10. A mixture for production of chlorine dioxide in water as recited in claim 3, wherein said hypochlorite containing material and said chlorocyanurate are present in said mixture at a ration of between 1:4 and 4:1.

11. A mixture for production of chlorine dioxide in water as recited in claim 3, wherein said hypochlorite containing material and said chlorocyanurate are present in said mixture at a ration of between 1.5:1 and 2.5:1

12. A mixture for production of chlorine dioxide in water, said mixture comprising:
(a) a chlorite salt,
(b) an oxidizing chlorine releasing agent, and
(c) an acid producing compound.

13. A mixture for production of chlorine dioxide in water as recited in claim 12, wherein said acid producing compound is aluminum sulfate.

14. A mixture for production of chlorine dioxide in water as recited in claim 13, wherein said aluminum sulfate is dehydrated prior to its inclusion into said mixture.

15. A mixture for production of chlorine dioxide in water as recited in claim 12, wherein said acid producing compound is ferrous sulfate.

16. A mixture for production of chlorine dioxide in water as recited in claim 12, wherein said acid producing compound is ferric chloride.

17. A method for delivery of a mixture for production of chlorine dioxide in water, said method comprising the steps of:
(a) sealing a pre-measured quantity of said mixture for production of chlorine dioxide in water in a water soluble container, and
(b) placing said water soluble container in a known volume of water.

18. A method for delivery of a mixture for production of chlorine dioxide in water as recited in claim 17, wherein said pre-measured quantity of said mixture is sufficient to produce at least 0.2-3 ppm of chlorine dioxide in said known volume of water.

19. A method for delivery of a mixture for production of chlorine dioxide in water as recited in claim 17, wherein said mixture contains a chlorite salt, a combination of oxidizing chlorine releasing agents and an acid source.

20. A method for delivery of a mixture for production of chlorine dioxide in water as recited in claim 17, wherein said mixture contains a chlorite salt, an oxidizing chlorine releasing agent and an acid producing compound.
